(19) United States
(12) Patent Application Publication
(10) Pub. No.: US 2006/0023252 A1
(43) Pub. Date: Feb. 2, 2006

(54) Image processing apparatus and image processing system

(76) Inventor: Kunio Kanai, Tokyo (JP)

Correspondence Address: RABIN & Berdo, PC, 1101 14TH STREET, NW, SUITE 500, WASHINGTON, DC, 20005, US

(21) Appl. No.: 11/187,871

(22) Filed: Jul. 25, 2005

(30) Foreign Application Priority Data
Jul. 27, 2004 (JP) 2004-218362

(51) Int. Cl. G06F 3/12; G06K 1/00

(52) U.S. Cl. 358/1.15; 358/1.6

(57) ABSTRACT

A print file having print data is transmitted to corresponding image forming apparatuses. A print management section manages first information that identifies a print file and second information that addresses an image forming apparatus. A print file monitoring section monitors a print file memory to detect whether a print file identified by the first information has been created. When said print file monitoring section determines that the print file has been created, a print file obtaining section obtains print data for the print file from the print file memory and the first information from said print management section. A transmitter obtains the second information from said print management section that corresponds to the first information obtained through said print file obtaining section. The transmitter transmits the print data for the print file to the image forming apparatus addressed by the second information.

### BACKGROUND OF THE INVENTION

1. Field of the Invention

The present invention relates to a printing system, and more particularly to a system in which a plurality of image processing apparatuses and image forming apparatuses are on a network.

2. Description of the Related Art

Conventional printing systems include a plurality of printers interconnected through a network. Among conventional printing systems is one in which when, for example, one local printer becomes inoperable, an alternative printer can be operated according to the level of priority stored in a sub-printer information memory. The data format of print data is converted into another data format according to a particular protocol supported by the alternative printer. The converted data is then transmitted to the alternative printer.

Such a conventional system is not capable of performing broadcast printing in which a print job can be sent to a plurality of printers in only one step or recipients can be selected depending on the content of the print data of the print job.

### SUMMARY OF THE INVENTION

An object of the present invention is to provide a printing system that solves the problems of conventional printing systems.

Another object of the invention is to provide a printing system capable of performing broadcast printing by using general purpose applications and drivers.

Still another object of the invention is to provide an excellent general purpose printing system.

A print file having print data is transmitted to corresponding image forming apparatuses. A print management section manages a first item of information that identifies a print file and a second item of information that addresses an image forming apparatus corresponding to the first item of information. A monitoring section monitors a print file memory to detect whether a print file identified by the first item of information has been created. When the monitoring section determines that the print file has been created, a print file obtaining section obtains print data for the print file from the print file memory and the first item of information from the print management section. A transmitter obtains the second item of information from the print management section that corresponds to the first item of information obtained through the print file obtaining section. The transmitter transmits the print data for the print file to the image forming apparatus addressed by the second item of information.

The first item of information is a file name of the print file.

The first item of information is a print directory to which the print file belongs.

The first item of information is a combination of a print file name of the print file and a print directory to which the print file belongs.

The print file name is a string of predetermined characters.

The print directory contains predetermined characters.

The print management section manages by correlating one item of first information to a plurality of image forming apparatuses to which the print data should be sent.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates a print network incorporating a printing system according to a first embodiment;

FIG. 2 is a block diagram illustrating a pertinent portion of the printing system;

FIG. 3 is a functional block diagram illustrating the print processing performed in a general purpose printing system;

FIG. 4 is a block diagram illustrating the print processing performed in a broadcast printing system;

FIG. 5 illustrates the configuration of a GUI that allows a user to produce file-destination information;

FIG. 6 illustrates the configuration of a GUI displayed when an “ADD” button or a “CHANGE” button is pressed;

FIG. 7 illustrates the content of a file-destination information management table according to the first embodiment;

FIG. 8 and FIG. 9 are flowcharts illustrating the flow of process during broadcast printing performed by the printing system;

FIG. 10 illustrates a specific process for the general purpose printing system produces a print file;

FIG. 11 illustrates a specific process for the broadcast printing system to transmit the print data of a print file “branch office. prn” to a corresponding one of image forming apparatuses;

FIG. 12 is a block diagram illustrating the printing process performed in a broadcast printing system employed in a printing system according to a second embodiment;

FIG. 13 illustrates the configuration of a GUI that allows a user to produce directory-destination information;

FIG. 14 illustrates the configuration of a GUI displayed when an “ADD” button or a “CHANGE” button is pressed;

FIG. 15 illustrates the content of a file-destination information management table according to the second embodiment;

FIG. 16 is a flowchart illustrating the flow of process during the broadcast printing performed by a broadcast printing system according to the second embodiment;

FIG. 17 illustrates a specific process from production of a print file “branch office. prn” until the print file is transmitted to a corresponding image forming apparatus;

FIG. 18 is a block diagram illustrating the printing process performed in a broadcast printing system employed in a printing system according to a third embodiment;

FIG. 19 illustrates the configuration of a GUI that allows a user to produce directory-destination information;

FIG. 20 illustrates the configuration of the GUI displayed when an “ADD” button or a “CHANGE” button is pressed;

FIG. 21 illustrates the content of a file-destination information management table according to the third embodiment;

FIG. 22 is a flowchart illustrating the flow of process during the broadcast printing performed by the broadcast printing system; and

FIG. 23 is a block diagram illustrating the printing process performed in a broadcast printing system employed in a printing system according to a fourth embodiment.

### DETAILED DESCRIPTION OF THE INVENTION

The present invention will be described in detail with reference to the accompanying drawings.

### First Embodiment

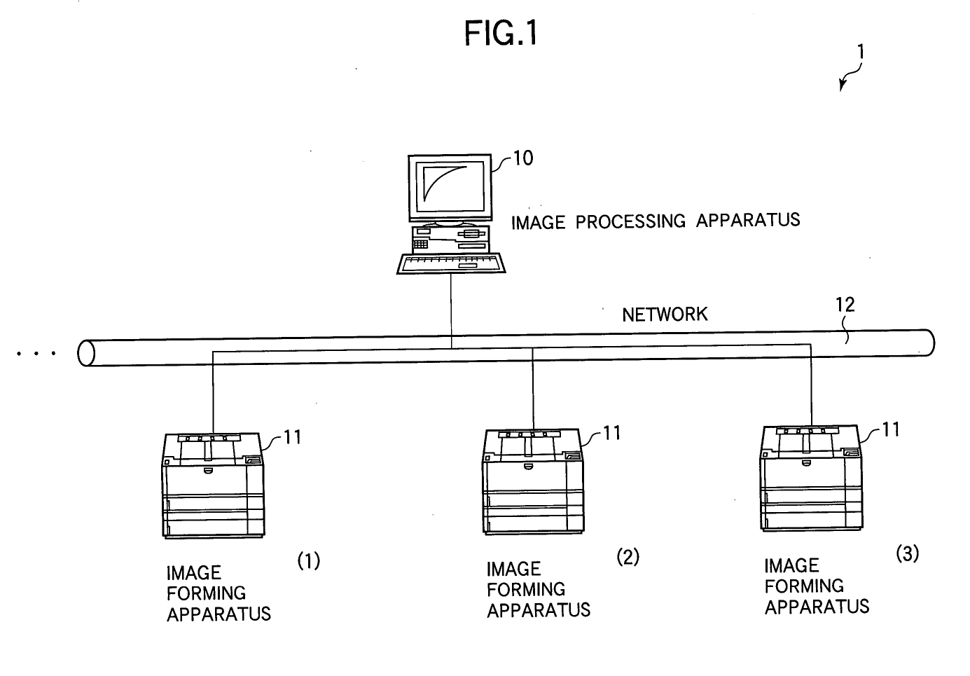

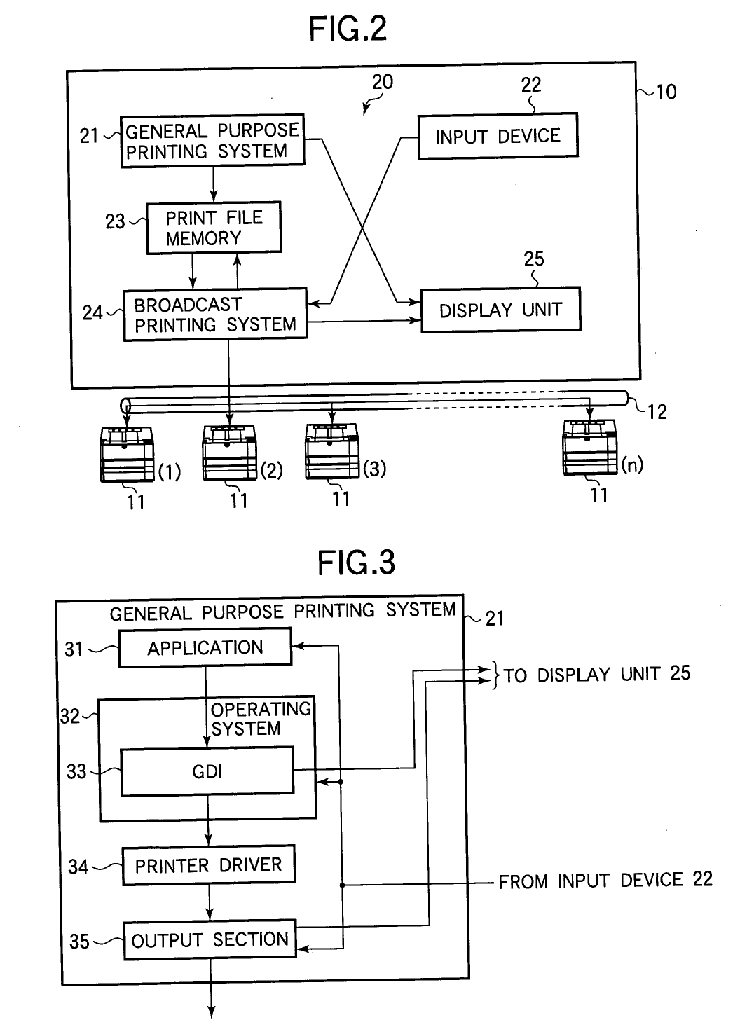

FIG. 1 illustrates a print network incorporating a printing system according to a first embodiment. FIG. 2 is a block diagram illustrating a pertinent portion of the printing system.

Referring to FIG. 1, a printing network 1 includes an information processing apparatus 10 and a plurality of image forming apparatuses 11(1)-11(n) interconnected through a network 12. As shown in FIG. 2, the information processing apparatus 10 incorporates a printing system 20 that uses a general purpose application and a printer driver for performing broadcast printing. The information processing apparatus 10 includes a general purpose printing system 21, an input device 22, a print file memory 23, a broadcast printing system 24, and a display unit 25. A broadcast printing system is a print system in which a single print job is sent to a plurality of printers in only one step. All the operations for pressing buttons on the GUI 101 and inputting data such as characters are performed through the input device 22.

The display unit 25 displays information held in the information processing apparatus 10 and graphical user interface (GUI) in the form of figures, characters, or images. The input device 22 includes a mouse and a keyboard, not shown. The user's requests are inputted at various stages of respective processes through the mouse and keyboard into the respective sections of the information processing apparatus 10.

FIG. 3 is a functional block diagram illustrating a print processing performed in the general purpose printing system 21. Referring to FIG. 3, an application 31 produces a print job. An operating system 32 manages the application 31, display unit 25, and input device 22. A graphics device interface (GDI) 33 provides graphics, which can not be printed in the image forming apparatuses 11(1)-11(n). A printer driver 34 converts the graphics into print data that the image forming apparatus 11(1)-11(n) can print. An output section 35 outputs the thus converted print data to the image forming apparatuses 11(1)-11(n) and the print file memory 23. The printer driver 34 converts the graphics into print data that can be printed in the image forming apparatus 11(1)-11(n).

The output section 35 converts print data into a print file. The print file is assigned a file name (referred to as print file name hereinafter), and is stored into the print file memory 23.

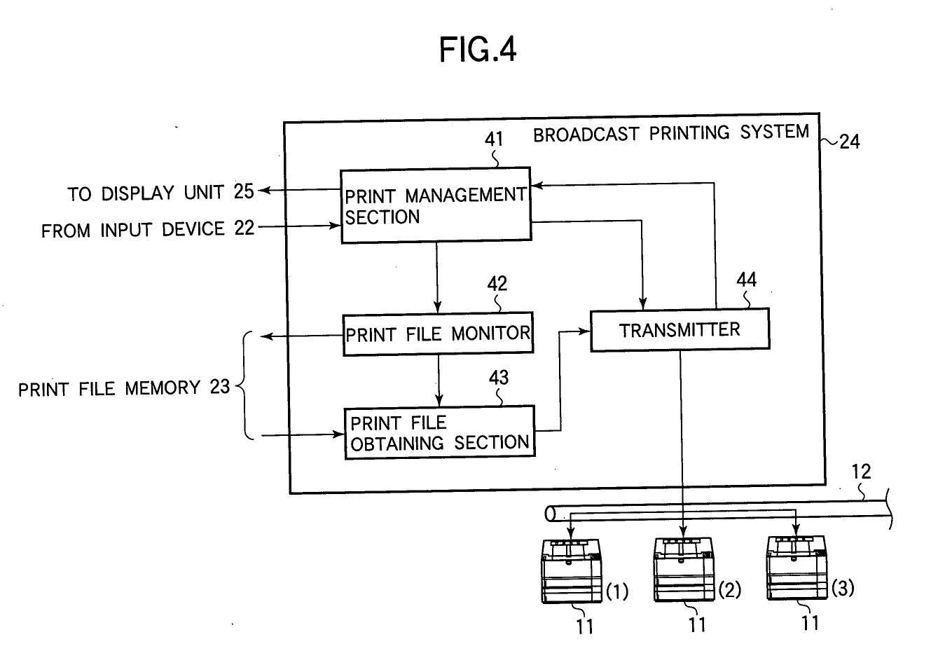

FIG. 4 is a block diagram illustrating the print processing performed in the broadcast printing system 24. Referring to FIG. 4, a print management section 41 stores items of identification information (referred to as destination information) for corresponding print files stored in the print file memory 23. A print file monitor 42 monitors the print files in the information processing apparatus 10 to determine whether a print file having the same print file name as is stored in the print management section 41 has been created. When the print file monitor 42 determines that the print file has been produced, a print file obtaining section 43 obtains the print file from the information processing apparatus 10. A transmitter 44 obtains an item of destination information corresponding to the print file from the print management section 41, and transmits the print data over the network 12 to a corresponding one of the image forming apparatuses 11(1)-11(n) addressed by the item of destination information.

The operation of the aforementioned broadcast printing system 24 will be described.

For performing broadcast printing, a print file name needs to be correlated to a corresponding item of destination information. File-destination information is a combination of a print file name and a corresponding item of destination information.

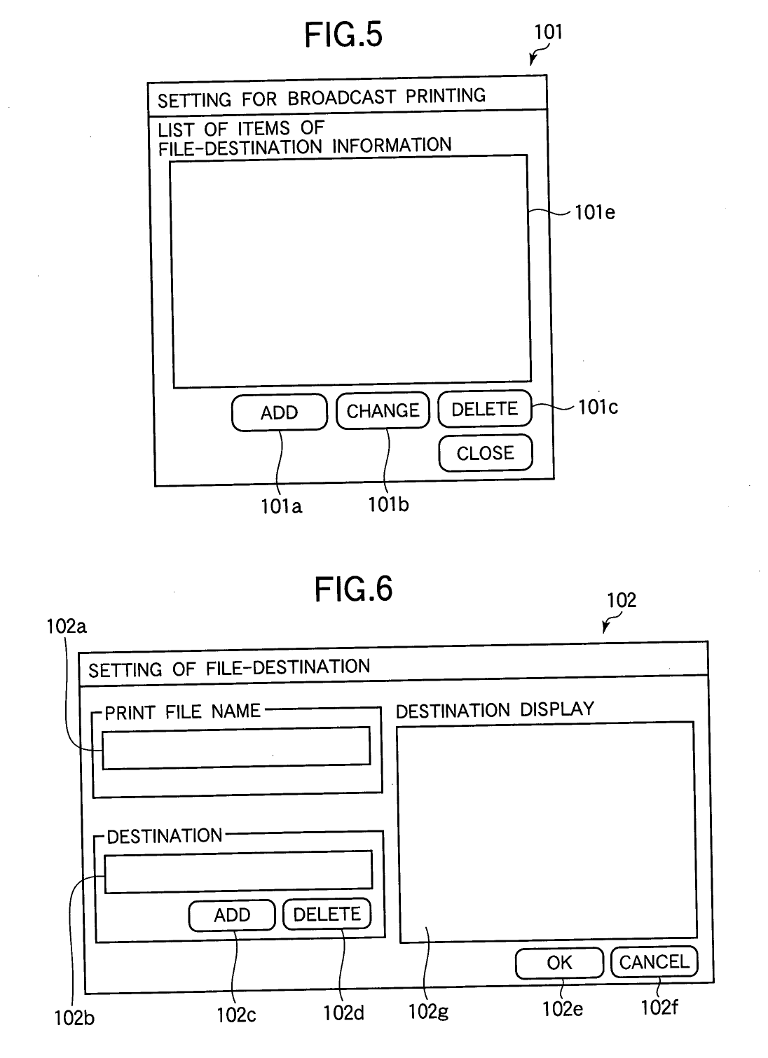

FIG. 5 illustrates the configuration of a GUI 101 that allows a user to produce the file-destination information. The print management section 41 controls the display unit 25 to display the GUI 101. A user selects an “ADD” button 101a on the GUI 101 through the input device 22 (FIG. 2) to produce a new item of file-destination information.

FIG. 6 illustrates the configuration of a GUI 101 displayed when the “ADD” button 101a or a “CHANGE” button 101b is pressed.

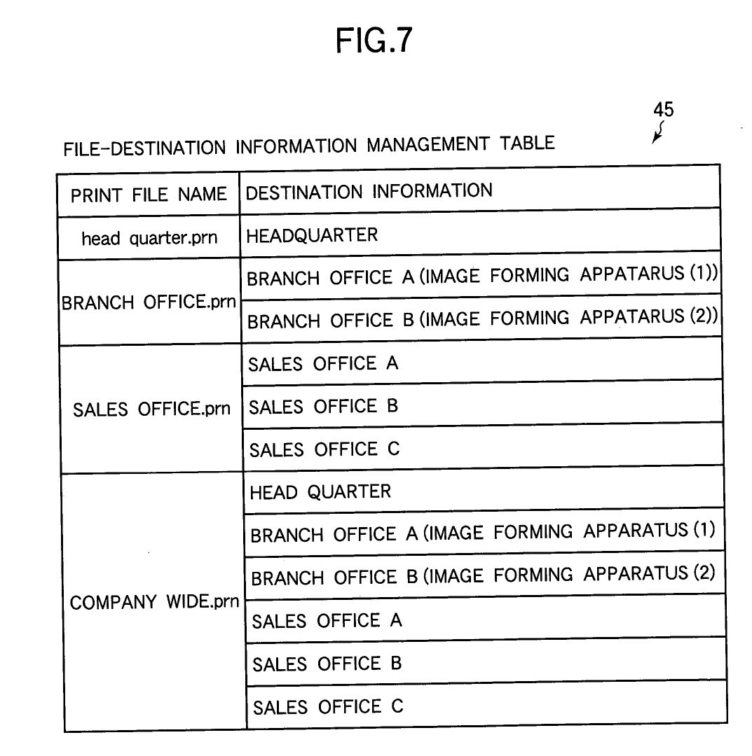

FIG. 7 illustrates the content of a file-destination information management table 45 according to the first embodiment.

When a new item of file-destination information is produced via the GUI 101, all areas to be filled in are initially displayed as a blank area. The user inputs a print file name into a print file name area 102a and destination information into a destination area 102b. The destination information addresses an image forming apparatus to which the print file having the print file name filled in the print file name area 102a should be sent.

Therefore, pressing the “ADD” button 102c causes the destination information in the destination area 102b to enter “a list of destination,” which then appears in a destination display area 102g. When a plurality of items of destination information are specified for broadcast printing, an item of destination information for a corresponding one of the destinations is inputted, followed by a press of the “ADD” button 102c. This operation is repeated for each of the destinations. In this manner, a plurality of items of destination information can be set for a single print file. If the user wants to delete an item of destination information, the item of destination information is first selected from among the items of destination information in the destination display area 102g. Then, the user presses a “DELETE” button 102d.

Pressing an “OK” button 102e causes the file-destination information to be stored into the file-destination management table 45 (FIG. 7), which will be described later, in the print management section 41. The file-destination information then appears in a list of items of file-destination information 101e. If the user wants to change an item of file-destination information in the list of items of file-destination information 101e, the user selects a desired item of file-destination information from among the items of file-destination information that appear in the list of item of file-destination information 101e. The user, then, presses the “CHANGE” button 101b. Thus, the display unit 25 returns to the GUI 102 in FIG. 6 that displays where the “OK” button 102e was pressed last. The GUI 102 allows the user to change the file-destination information.

If the user wants to delete an item of file-destination information from the list of item of file-destination information 101e, the user selects a desired item of file-destination information from among the items of file-destination information that appear in the list of item of file-destination information 101e. The user, then, presses the “DELETE” button 101c. In this manner, the selected item of file-destination information is deleted. The items of file-destination information are saved in a table 45 (FIG. 7) in the print management section 41.

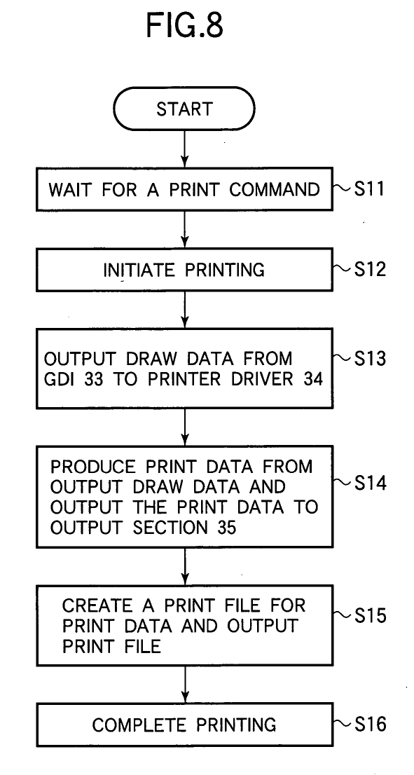

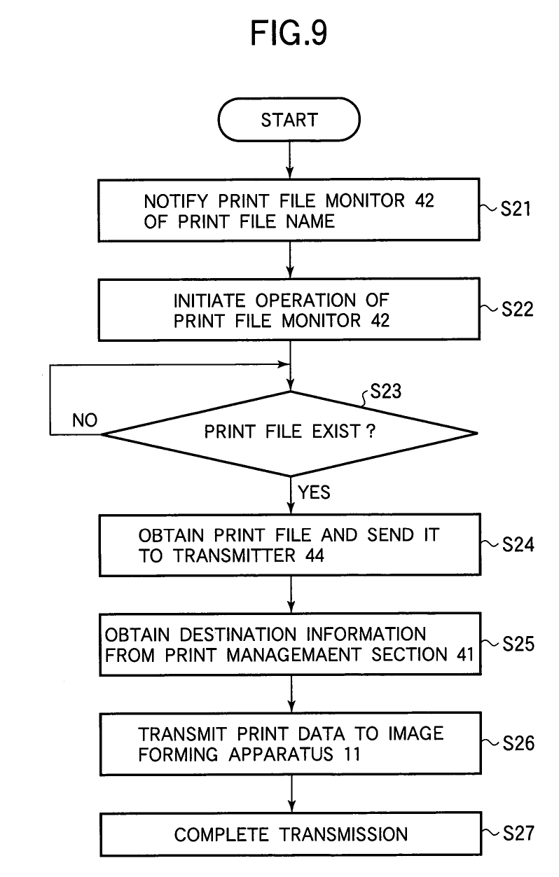

FIG. 8 and FIG. 9 are flowcharts illustrating the flow of process during the broadcast printing performed by the printing system 20.

When the general purpose printing system 21 (FIG. 3) operates to initiate printing (step S11 and step S12), draw data produced by the application 31 is sent to the printer driver 34 via a GDI 33 (step S13). The printer driver 34 produces print data to be outputted to the image forming apparatus 11, the print data being produced based on the draw data. The printer driver 34 then outputs the thus produced print data to the output section 35 (step S14). The output section 35 receives the print data from the printer driver 34, and outputs the print data as a print file (step S15). At this moment, a print file name is created. The output section 35 causes a GUI to appear on the display unit 25, the GUI prompting the user to input a print file name. Alternatively, the output section 35 may set a print file name by selecting from among previously stored in the file-destination management table 45. In this manner, the print data is outputted as a print file to the print file memory 23 (FIG. 2), the general purpose printing system 21 completing printing (step S16).

The broadcast printing system 24 is up and running on the printing system 20 even when the general purpose printing system 21 is operating. The print management section 41 notifies the print file name in the file-destination management table 45 (FIG. 7) to the print file monitor 42 (step S21). The print file monitor 42 monitors the print files in the information processing apparatus 10 at all times. If the print file monitor 42 finds a print file having the notified print file name in the information processing apparatus 10, the print file monitor 42 notifies the print file obtaining section 43, so that the print file obtaining section 43 obtains the print file from the print file memory 23 (steps S22 and S23).

In response to the notification from the print file monitor 42, the print file obtaining section 43 obtains the print file and transfers it (i.e., print file name+print data) to the transmitter 44 (step S24). The transmitter 44 then transmits the print file name to the print management section 41 to obtain the destination information that addresses an image forming apparatus 11 to which the print file should be sent (step S25). Then, the transmitter 44 transmits the print data over the network 12 to the image forming apparatus 11 addressed by the destination information (step S26), so that the broadcast printing system 24 completes the transmission of the print data (step S27).

A description will be given of how the print data is transmitted to the image forming apparatus 11, assuming that the print file name in the file-destination management table 45 (FIG. 7) has been produced.

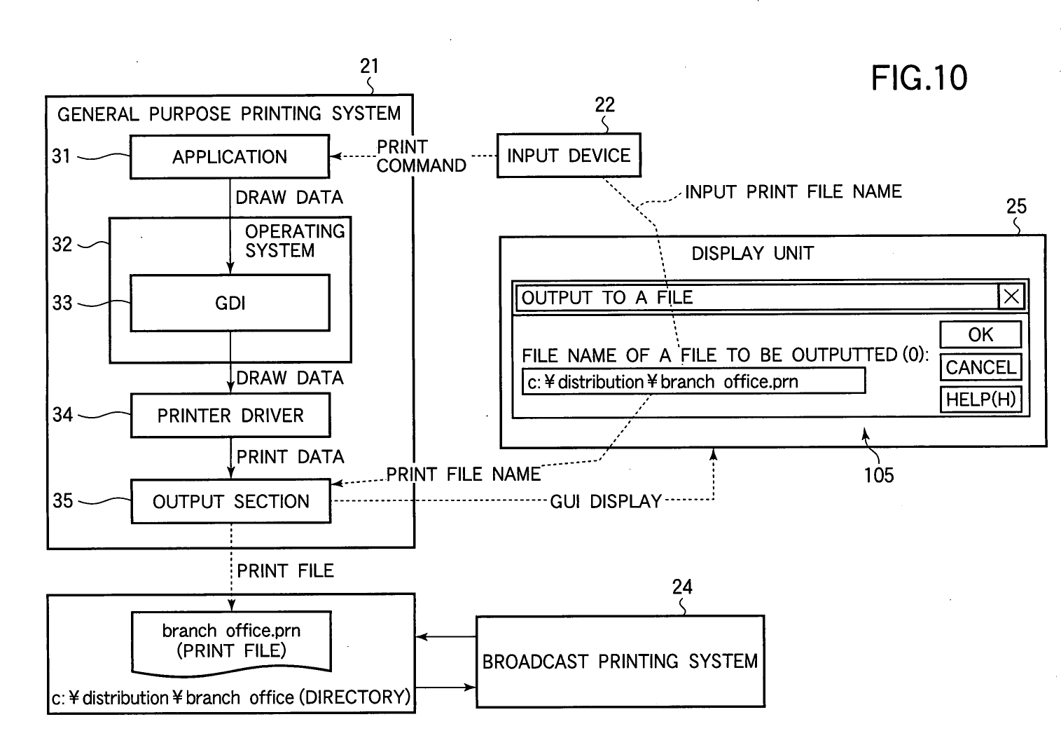

FIG. 10 illustrates a specific process for the general purpose printing system 21 to produce a print file. When the application 31 receives a print command the through the input device 22, the general purpose printing system 21 produces print data through the GDI 33 and printer driver 34. The output section 35 receives the thus produced print data, and displays a GUI 105 on the display unit 25 to prompt the user to input a print file name. When the user inputs a file name in the form of a character string of specific characters shown in FIG. 10 into the GUI 105, the output section 35 creates a print file in the print file memory 23, the print file having a print directory “c:¥distribution¥branch office” and a print file name “branch office. prn”.

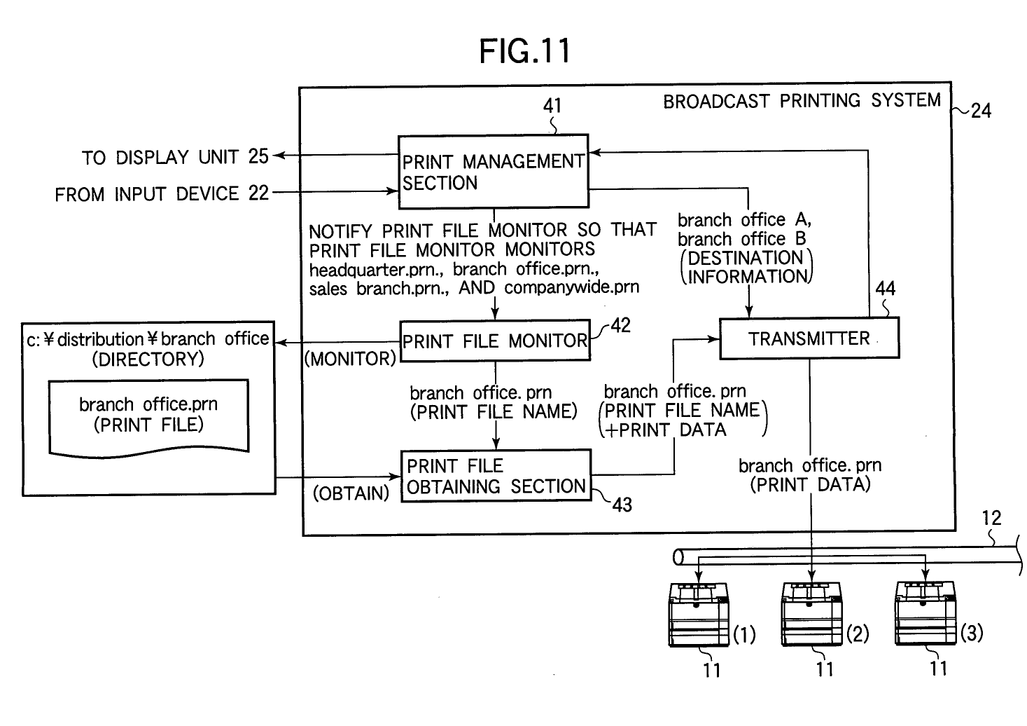

FIG. 11 illustrates the specific process for the broadcast printing system 24 to transmit the print data of the print file “branch office. prn” to a corresponding one of the image forming apparatuses 11(1)-11(n). At this moment, the print file monitor 42 monitors the respective file names, i.e., “head quarter. prn,” “branch office. prn,” “sales branch. prn,” and “company wide. prn.” When the print file name “branch office. prn” has been produced, the print file monitor 42 notifies the print file obtaining section 43 of the print file name “branch office. prn.”

In response to the notification, the print file obtaining section 43 obtains the print file name “branch office. prn” and corresponding print data, and delivers the print file name “branch office. prn” and the print data having this file name to the transmitter 44. The transmitter 44 receives the print file name “branch office. prn” and print data, then notifies the print management section 41 of the print file name. The print management section 41 delivers destination information “branch office A” and “branch office B” stored in the file-destination management table 45 to the transmitter 44. The transmitter 44 transmits the print data and the print file name “branch. prn” to corresponding ones of the image forming apparatus 11(1)-11(n), i.e., image forming apparatus (1) and image forming apparatus (2). The first embodiment has been described with respect to a file name such as “head office,” “branch office,” and “sales office.” Alternatively, when the file name is, for example, “branch office *.prn” (* is a wild card), the print data may be transmitted using only “branch office” as a destination.

As described above, the printing network 1 according to the first embodiment allows the general purpose printing system incorporating general purpose applications and printer driver to perform broadcast printing without modifying the general purpose applications and printer driver. A plurality of combinations of print file names and image forming apparatuses are created and entered in a list, so that the print data for a print file name is printed in corresponding image forming apparatuses.

### Second Embodiment

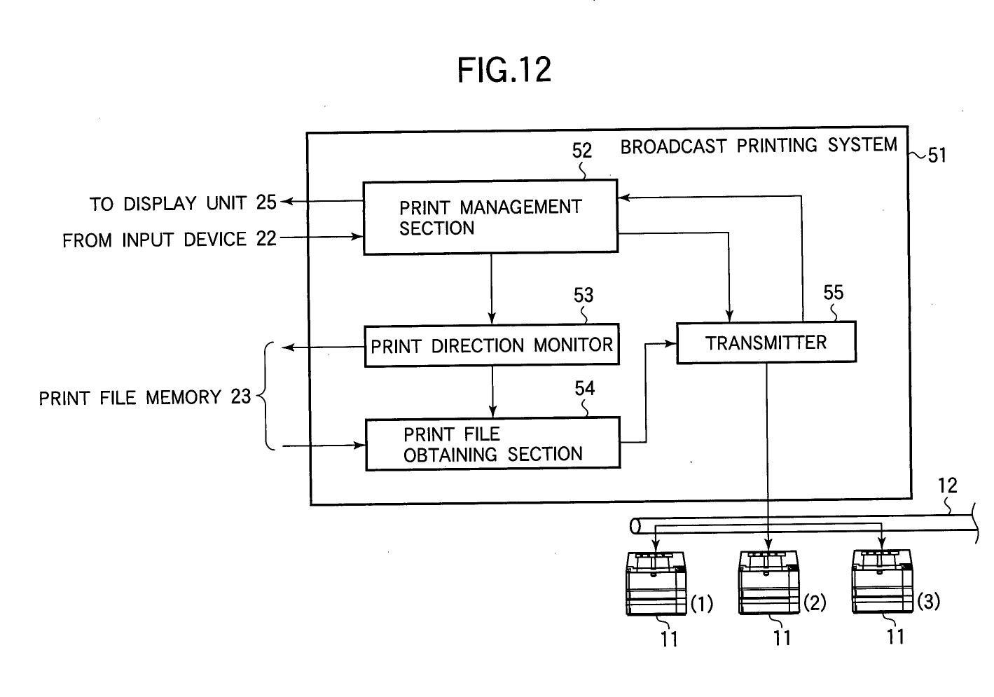

FIG. 12 is a block diagram illustrating the printing process performed in a broadcast printing system 51 employed in a printing system according to a second embodiment.

The printing system according to the second embodiment differs from that according to the first embodiment in the processing performed in the broadcast printing system 51. Elements similar to those in the first embodiment have been given the same reference numerals and their description is omitted. With reference to FIG. 12, the printing system according to the second embodiment will be described in terms of a portion different from the first embodiment.

Referring to FIG. 12, a print management section 52 stores a print directory to which print files belong and items of identification information (referred to as destination information hereinafter) for the print files. The items of destination information are correlated with the print files. A print directory monitor 53 monitors the print directory and sub-directories in the print directory to determine whether a print file has been produced. If the print directory monitor 53 determines that a print file has been produced in the print directory or in the sub-directory, a print file obtaining section 54 obtains the print file and the print directory. A transmitter 55 obtains items of destination information corresponding to the print file from the print management section 52 and print data via the print file obtaining section 54. The transmitter 55 then transmits the print data for the print file over the network 12 to corresponding ones of the image forming apparatuses 11(1)-11(n) addressed by the items of destination information.

The operation of the aforementioned broadcast printing system 51 will be described.

For performing broadcast printing, a print directory to which the print file belongs is correlated to an item of destination information. Directory-destination information is a combination of a print directory to which a print file belongs and a corresponding item of destination information.

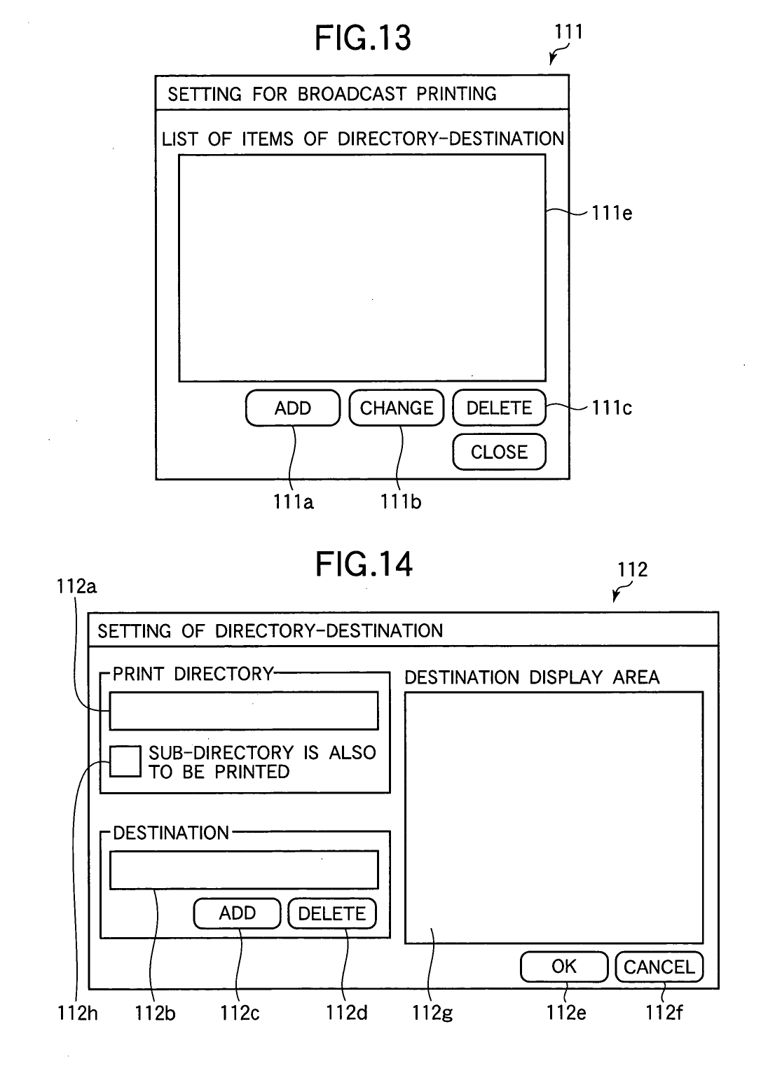

FIG. 13 illustrates the configuration of a GUI 111 that allows a user to produce the directory-destination information. The print management section 52 controls the display unit 25 (FIG. 2) to display the GUI 111. A user selects “ADD” button 101a on the GUI 111 through the input device 22 (FIG. 2) to produce a new item of directory-destination information. All the operations for pressing buttons on the GUI 111 and inputting data such as characters are performed through the input device 22.

FIG. 14 illustrates the configuration of the GUI 111 displayed when the “ADD” button 111a or the “CHANGE” button 111b is pressed to create a new item of directory-destination information or change an item of directory-destination information.

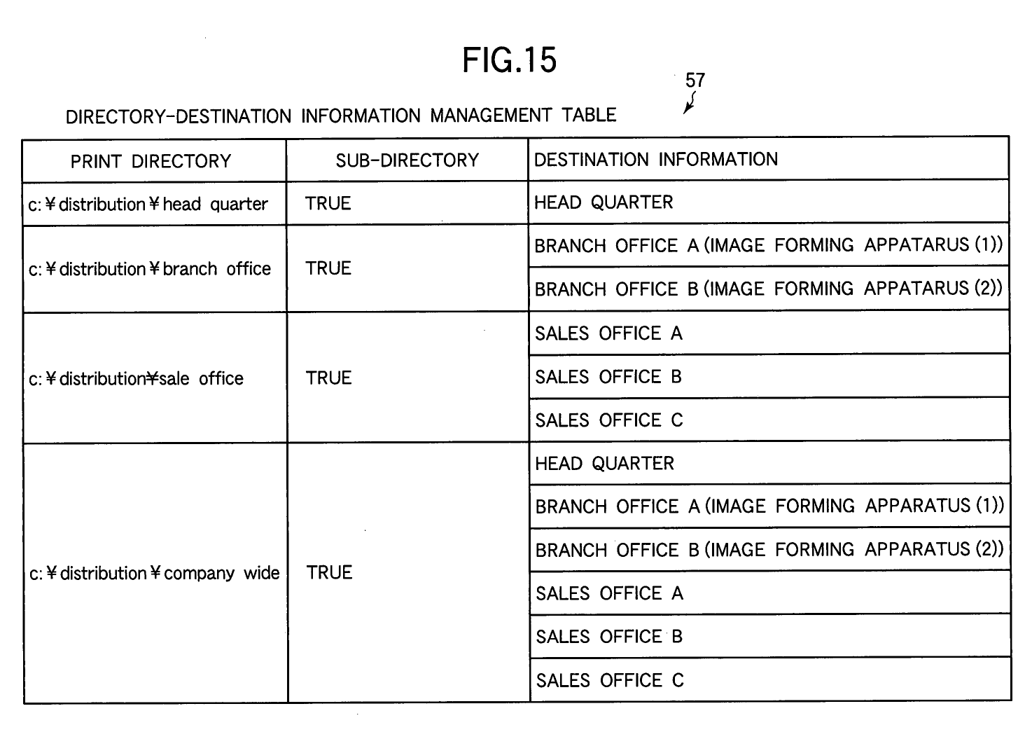

FIG. 15 illustrates the content of a directory-destination information management table according to the second embodiment.

When a new item of directory-destination information is produced via the GUI 111, all areas to be filled in are initially displayed as a blank area. The user inputs a print directory into a print directory area 112a and destination information into a destination area 112b. The destination information addresses an image forming apparatus to which a print file that belongs to the print directory in the print directory area 112a should be sent. If a print file in the sub-directory is also to be printed, a check is placed in a checkbox 112h for “sub-directory is also printed.”

Thereafter, pressing the “ADD” button 112c causes the destination information in the destination area 112b to enter “a list of destination,” which in turn appears in a destination display area 112g. For broadcast printing, a plurality of destinations are addressed as follows: An item of destination information for a corresponding one of the destinations is inputted, followed by a press of the “ADD” button 112c. This operation is repeated for each of the destinations. In this manner, a plurality of items of destination information can be set for a single print file. If an item of destination information should be deleted, the item of destination information is first selected from among the items of destination information in the destination display area 112g. Then, a “DELETE” button 112d is pressed.

Pressing an “OK” button 112e causes the directory-destination information to be stored into a directory-destination information management table 57 (FIG. 15), which will be described later, in the print management section 52. The directory-destination information then appears in a list of items of directory-destination information 111e. If the user wants to change an item of directory-destination information in the list of items of directory-destination information 111e, the user selects a desired item of directory-destination information from among the items of directory-destination information in the list of item of directory-destination information 111e, and then presses the “CHANGE” button 111b. The display unit 25 returns to the GUT 112 in FIG. 14 that displays a screen where the “OK” button was pressed last. The GUT 112 allows the user to change the directory-destination information.

If the user wants to delete an item of directory-destination information in the list of items of directory-destination information 111e, the user selects a desired item of directory-destination information from among the items of file-destination information in the list of item of directory-destination information 111e. The user, then, presses the “DELETE” button 111c. In this manner, the desired item of directory-destination information is deleted. The items of directory-destination information are saved in the directory-destination information management table 57 (FIG. 15).

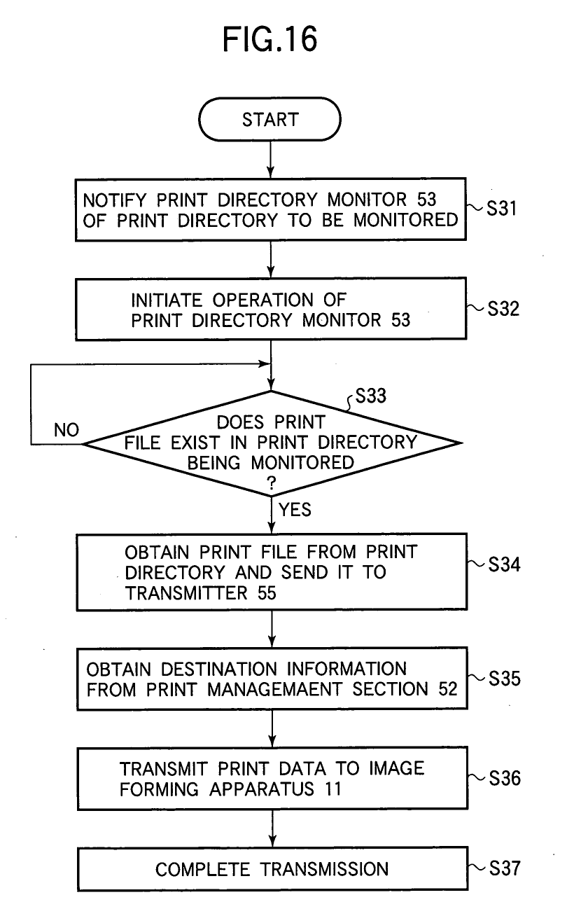

FIG. 16 is a flowchart illustrating the flow of process during the broadcast printing performed by the broadcast printing system 51. The operation of a general purpose printing system according to the second embodiment is the same as that of the general purpose printing system 21 in FIG. 3, and therefore the description thereof is omitted.

The broadcast printing system 51 is up and running on the printing system even when the general purpose printing system 21 (same as the general purpose printing system 21 in FIG. 3) is operating. The print management section 52 notifies the directory in the directory-destination information management table 57 (FIG. 15) to the print directory monitor 53. If a print file in the sub-directory is also to be printed, a check is placed in a checkbox 112h for “sub-directory is also to be printed” in the GUI 112 (step S31). The print directory monitor 53 monitors the print directory in the information processing apparatus 10 at all times. If the print directory monitor 53 finds a print file that belongs to the notified print directory, the print directory monitor 53 notifies the print file obtaining section 54, so that the print directory obtaining section 54 obtains a corresponding print file from the print file memory 23 (step S32 and S33).

In response to the notification from the print directory monitor 53, the print directory obtaining section 54 obtains the print directory and transfers it (i.e., print file name+print data) to the transmitter 55 (step S34). The transmitter 55 transmits the print directory to the print management section 52 to obtain the destination information that addresses one of image forming apparatus 11(1)-11(n) to which the print file should be sent (step S35). Then, the transmitter 55 transmits the print data to the image forming apparatus addressed by the destination information over the network 12 (step S36), so that the broadcast printing system 51 completes the transmission of the print data (step S37).

A description will be given of how the print data is transmitted to the image forming apparatus, assuming that the directory-destination information management table 57 (FIG. 15) has been created. The operation of a general purpose printing system according to the second embodiment is the same as that of the general purpose printing system 21 in FIG. 3, and therefore the description thereof is omitted.

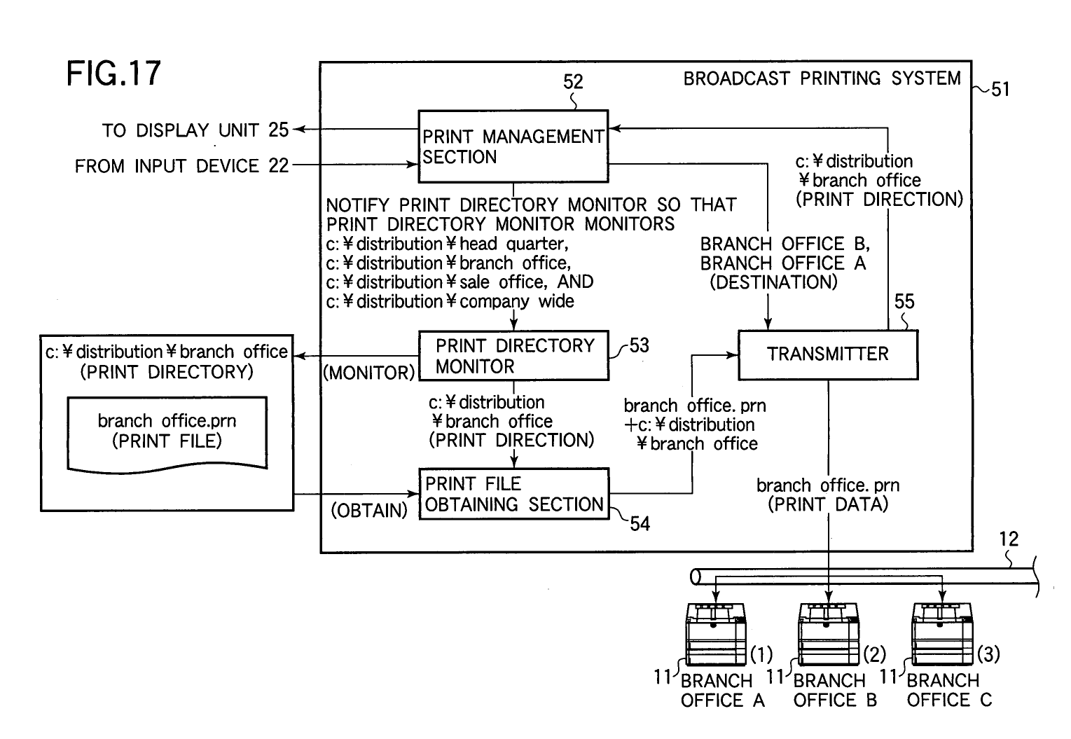

FIG. 17 illustrates a specific process from the production of a print file “branch office. prn” until the print file is transmitted to a corresponding one of the image forming apparatuses 11(1)-11(n). At this moment, the print directory monitor 53 monitors the respective print directories, i.e., “c:¥distribution¥head quarter,” “c:¥distribution¥branch office,” “c:¥distribution¥sales branch,” and “c:¥distribution¥company wide.” Upon producing a print file for “branch office. prn” in the “c:¥distribution¥branch office,” the print directory monitor 53 determines that a “branch office. prn” to be transmitted has been produced and notifies the print file obtaining section 54 of the print directory “c:¥distribution¥branch office”.

In response to the notification, the print file obtaining section 54 obtains the print file “branch office. prn” from the print directory “c:¥distribution¥branch office,” and delivers the print file “branch office. prn” to the transmitter 55 together with the print directory “c:¥distribution¥branch office.” The transmitter 55 receives the print directory “c:¥distribution¥branch office.” and notifies the print management section 52 of the print directory “c:¥distribution¥branch office.” The print management section 52 delivers destination information “branch office A” and destination information “branch office B”, stored in the directory-destination information management table 57, to the transmitter 55. The transmitter 55 transmits the print data of the print file “branch. prn” to corresponding ones of the image forming apparatuses 11(1)-11(n), i.e., image forming apparatus (1) and image forming apparatus (2).

As described above, the printing network 1 according to the second embodiment allows performing of broadcast printing without modifying a general purpose printing system that incorporates general purpose applications and a printer driver. A plurality of combinations of print file names and image forming apparatuses are created and entered in a list, so that the print data of a print file name can be printed in corresponding image forming apparatuses. Because it is only necessary to monitor a produced print directory, the burden on the information processing apparatus is alleviated.

### Third Embodiment

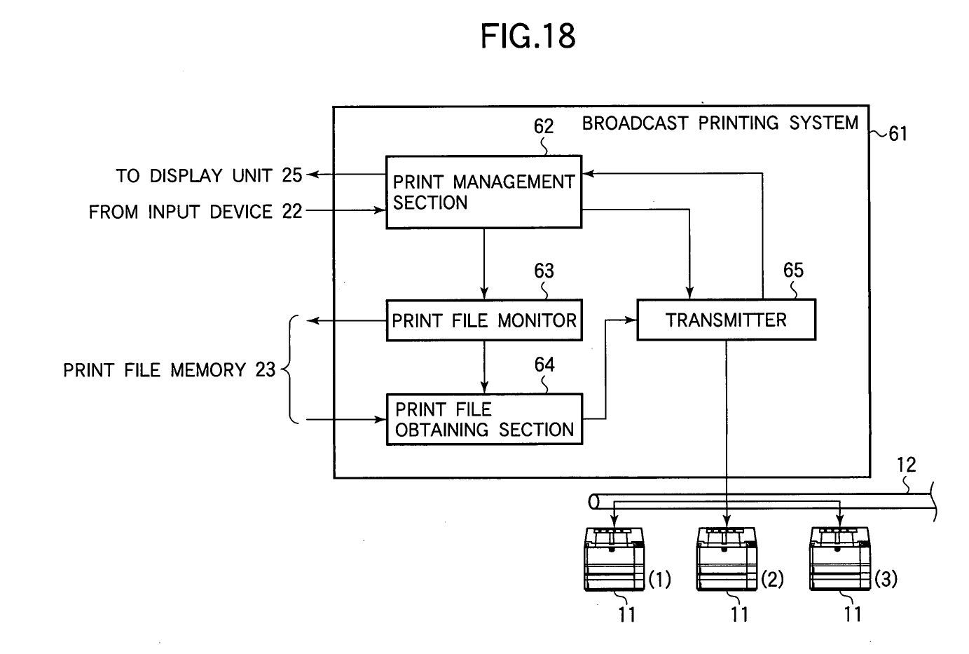

FIG. 18 is a block diagram illustrating the printing process performed in a broadcast printing system 61 employed in a printing system according to a third embodiment.

The printing system according to the third embodiment differs from that according to the first embodiment is in the processing performed in the broadcast printing system 61. Elements similar to those in the first embodiment have been given the same reference numerals and their description is omitted. The printing system according to the third embodiment will be described with reference to FIG. 18 in terms of a portion different from the first embodiment.

Referring to FIG. 18, a print management section 62 stores a print directory and identification information (referred to as destination information hereinafter) for corresponding print files stored in the print file memory 23. A print monitor 63 monitors the print directory and sub-directories in the print directory to determine whether a print file has been produced. If the print monitor 63 determines that a print file has been produced in the print directory or in the sub-directory, the print monitor 63 obtains the print file and the print directory. A transmitter 65 obtains an item of destination information corresponding to the print file from the print management section 62, and the print data corresponding to the print file that the print file obtaining section 64 obtained from the print file memory 23. The transmitter 65 then transmits the print file over the network 12 to corresponding ones of the image forming apparatuses 11 addressed by the items of destination information.

The operation of the aforementioned broadcast printing system 61 will be described.

For performing broadcast printing, a print file name, a print directory to which the print file belongs, and an item of destination information need to be correlated. File-directory-destination information is a combination of a print file name, a print directory to which the print file belongs, and a corresponding item of destination information.

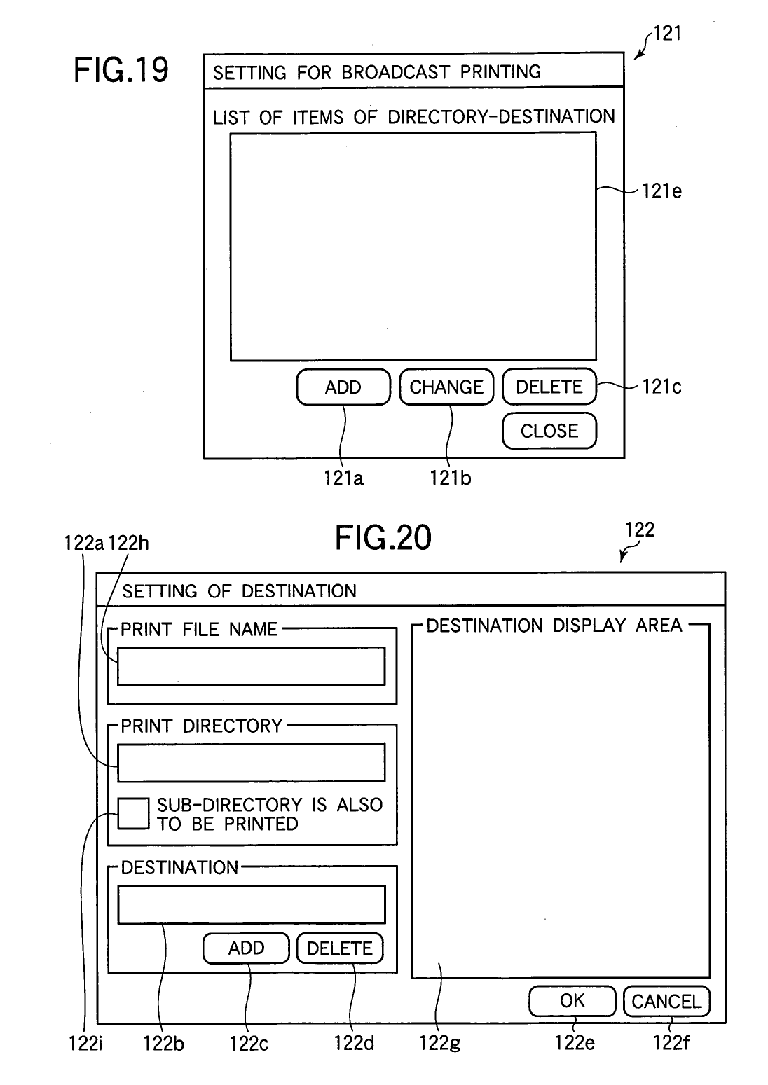

FIG. 19 illustrates the configuration of a GUI 121 that allows a user to produce the directory-destination information. The print management section 62 controls the display unit 25 (FIG. 2) to display the GUI 121. A user selects an “ADD” button 121a on the GUI 121 through the input device 22 (FIG. 2) to create a new item of file-directory-destination information. All the operations for pressing buttons on the GUI 121 and inputting data such as characters are performed through the input device 22.

FIG. 20 illustrates the configuration of the GUI 121 displayed when the “ADD” button 111a or a “CHANGE” button 111b is pressed.

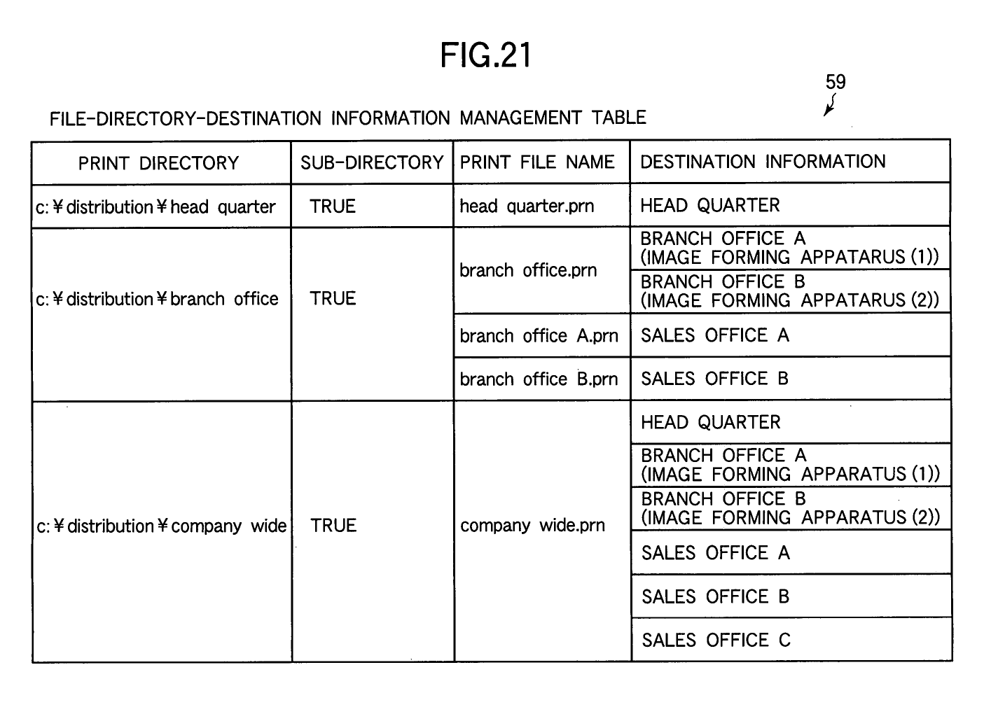

FIG. 21 illustrates the content of file-destination information management table 59 according to the third embodiment. When a new item of file-directory-destination information is produced via the GUI 121, all areas to be filled in are initially displayed as a blank area. The user inputs a print file name, a print directory, and destination information into a print file name area 122h, a print directory area 112a, and a destination area 112b, respectively. The destination information addresses an image forming apparatus 11 to which the print file that belongs to the print directory in the print directory area 112a should be sent. If a print file in the sub-directory is also to be printed, a check is placed in a checkbox 122i for “sub-directory is also to be printed.”

Thereafter, pressing the “ADD” button 122c, causes the destination information in the destination area 122b to enter “a list of destination”, which then appears in a destination display area 122g. For broadcast printing, two or more than two destinations are addressed as follows: An item of destination information for a corresponding one of the destinations is inputted, followed by a press of the “ADD” button 102c. This operation is repeated for each of the destinations. In this manner, a plurality of items of destination information can be correlated to a pair of a single print file and a print directory. If an item of destination information should be deleted, the item of destination information is first selected from among the items of destination information in the destination display area 122g. Then, a “DELETE” button 102d is pressed.

Pressing an “OK” button 122e causes the file-directory-destination information to be stored into a file-directory-destination management table 59 (FIG. 21), which will be described later, in the print management section 62. The file-directory-destination information then appears in a list of item of directory-destination information 121e. If the user wants to change an item of file-directory-destination information in the list, the user selects a desired item of file-directory-destination information from among the items of file-directory-destination information in the list of item of file-directory-destination information 121e, and then presses the “CHANGE” button 111b. The display unit 25 returns to the GUI 122 in FIG. 20 that displays a screen where the “OK” button was pressed last. In this manner, the GUI 122 allows the user to change the file-directory-destination information.

If the user wants to delete an item of file-directory-destination information in the list, the user selects a desired item of file-directory-destination information from among the items of file-directory-destination information in the list of item of file-directory-destination information 121e, and then presses the “DELETE” button 121c. In this manner, the desired item of file-directory-destination information is deleted. The items of file-directory-destination information are saved in the file-directory-destination management table 59 in FIG. 21.

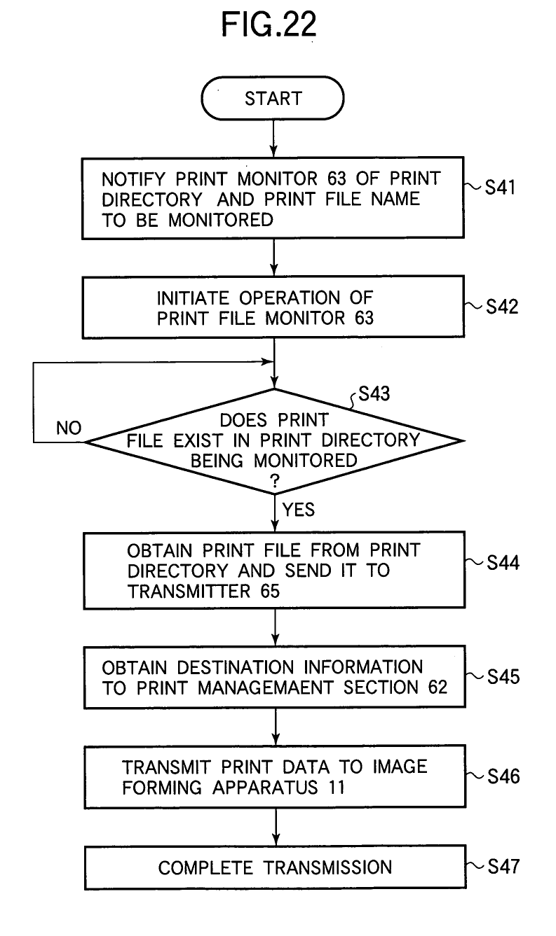

FIG. 22 is a flowchart illustrating the flow of process during the broadcast printing performed by the broadcast printing system 61. The operation of a general purpose printing system according to the third embodiment is the same as that of the general purpose printing system 21 in FIG. 3, and therefore the description thereof is omitted.

The broadcast printing system 61 is up and running on the printing system even when the general purpose printing system (same as the general purpose printing system 21 in FIG. 3) is operating. The print management section 62 notifies the print monitor 63 of a print file name and a directory in the file-directory-destination management table 59 (FIG. 21). If a print file in the sub-directory is also to be printed, a check is placed in a che.ckbox 122i for “sub-directory is also to be printed” in the GUI 122 (step S41). The print monitor 63 monitors the print directory in the information processing apparatus 10 at all times. If the print monitor 63 finds a print file having the notified file name in the directory or sub-directory, the print monitor 63 notifies the print file obtaining section 64 so that the print file obtaining section 64 obtains the print file from the print file memory 23 (steps S42 and S43).

In response to the notification from the print monitor 63, the print file obtaining section 64 obtains the print file having a specified print file name from a specified print directory, and transfers the print file name and print directory to the transmitter 65 (step S44). The transmitter 65 then transmits the print directory and the print file name to the print management section 62 to obtain the destination information that addresses an image forming apparatus 11 to which the print file should be sent (step S45). The transmitter 65 then transmits the print data to the image forming apparatus 11 addressed by the destination information over the network 12 (steps S46). Thus, the broadcast printing system 61 complete the transmission of the print data (steps S47).

As described above, the printing network 1 according to the third embodiment allows performing of broadcast printing without modifying a general purpose printing system that incorporates general purpose applications and a printer driver. A plurality of combinations of a directory, print file names, and image-forming apparatuses are created and entered in a list, so that the print data having a print file name that belongs to the print directory can be printed by means of corresponding image forming apparatuses. Because it is only necessary to monitor a produced print directory, the burden on the information processing apparatus is alleviated. Further, because a destination is determined by the produced print directory and produced print file name, print files for different destinations can be stored in the same print directory.

### Fourth Embodiment

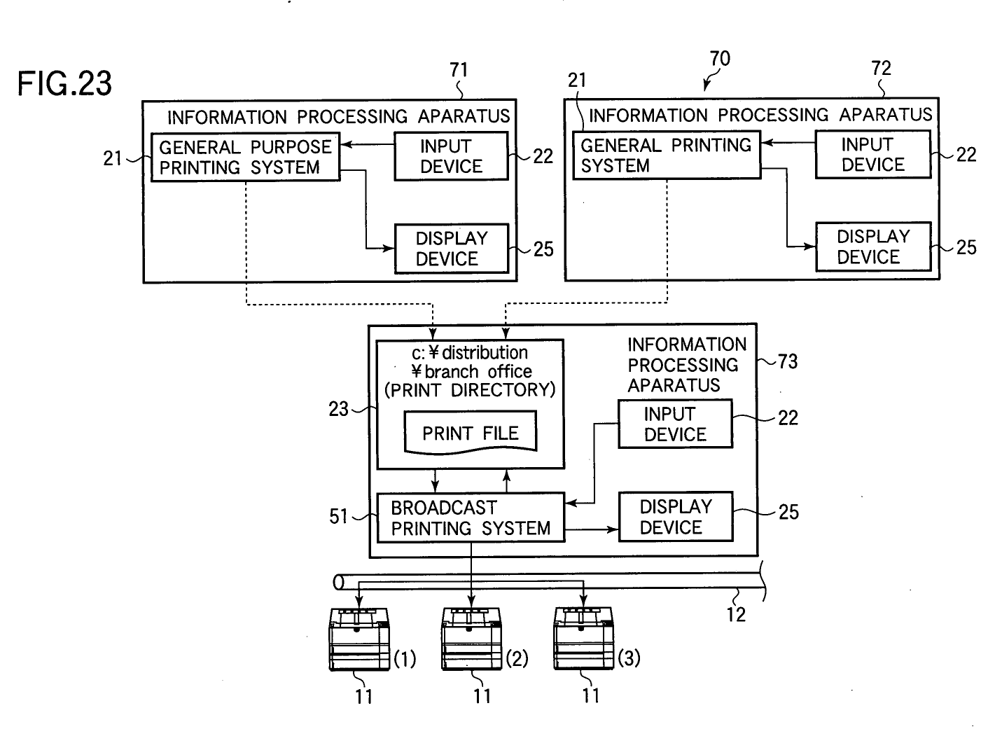

FIG. 23 is a block diagram illustrating the printing process performed in a broadcast printing system 70 employed in a printing system according to a fourth embodiment.

The aforementioned embodiments has been described with respect to a case in which a general purpose printing system and a broadcast printing system are operating on the same information processing apparatus. The printing system 70 according to the fourth embodiment has a feature that the general purpose printing system 21 and the broadcast printing system 51 are mounted on separate information processing apparatuses.

Referring to FIG. 23, the printing system 70 includes information processing apparatuses 71, 72, and 73. Each of the information processing apparatuses 71 and 72 includes an input device 22, a display device 25, and a printing system 21. The image processing apparatus 73 includes an input device 22, a display device 25, print file memory 23, and the broadcast printing system 51. The input device 22, display device 25, printing system 21, print file memory 23, and broadcast printing system 51 are the same as those in the first and second embodiments and therefore their description is omitted. However, the broadcast printing system 51 includes a directory-destination information management table 57 in FIG. 15.

With the printing system 70, for example, the information processing apparatus 71 or information processing apparatus 72 produces a print file. Then, the print file is stored into a print directory “c:¥distribution¥ branch office” created in the print file memory 23 of the information processing apparatus 73, so that the print data can be sent to an image forming apparatus 11(1) and image forming apparatus 11(2) that have items of destination information for branch office A and branch office B, respectively.

If the user desires to modify the destination so that the print data is sent to branch office C in addition to branch office A and branch office B, then the branch office C may be added to the destination information in the directory-destination information table 57 (FIG. 15) in the information processing apparatus 73. The addition of branch office C can be accomplished in the manner described in the second embodiment.

As described above, according to the present invention, a single image processing apparatus incorporates a broadcast printing system, so that a plurality of image processing apparatuses can produce items of print data individually by way of broadcast printing. Addition and deletion of destination for broadcast printing can be accomplished by merely changing the correlation of the print directory and destination information in a single broadcast printing system. This allows simple and quick alteration of the destination.

While the fourth embodiment has been described with respect to a case in which the print file memory 23 that stores the print files and the broadcast printing system 51 are provided in the same information processing apparatus 73, the invention is not limited to this. Modifications can be made such that the print file memory 23 may be provided in another information processing apparatus. Further, the fourth embodiment may employ the broadcast printing system 24 according to the first embodiment or the broadcast printing system 61 according to the third embodiment.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. An image processing apparatus in which a print file with print data is transmitted to corresponding image forming apparatuses that print the print data, the apparatus comprising:
a print management section that manages a first item of information that identifies a print file and a second item of information that addresses an image forming apparatus corresponding to the first item of information;
a monitoring section that monitors an print file memory to detect whether a print file identified by the first item of information has been created;
a print file obtaining section that obtains print data for the print file from the print file memory and the first item of information from said print management section when said monitoring section determines that the print file has been created;
a transmitting section that obtains the second item of information from said print management section that corresponds to the first item of information obtained through said print file obtaining section, said transmitting section transmitting the print data for the print file to the image forming apparatus addressed by the second item of information.

2. The image processing apparatus according to claim 1, wherein the first item of information is a file name of the print file.

3. The image processing apparatus according to claim 2, wherein said print management section performs management by correlating the first item of information to a plurality of image forming apparatuses to which the print data should be sent.

4. The image processing apparatus according to claim 2, wherein the print file name includes a string of predetermined characters.

5. The image processing apparatus according to claim 5, wherein said print management section manages by correlating the first item of information to a plurality of image forming apparatuses to which the print data should be sent.

6. The image processing apparatus according to claim 1, wherein the first item of information is a print directory to which the print file belongs.

7. The image processing apparatus according to claim 3, wherein the print file name includes a string of predetermined characters.

8. The image processing apparatus according to claim 6, wherein said print management section manages by correlating the first item of information to a plurality of image forming apparatuses to which the print data should be sent.

9. The image processing apparatus according to claim 3, wherein said print management section manages by correlating the first item of information to a plurality of image forming apparatuses to which the print data should be sent.

10. The image processing apparatus according to claim 1, wherein the first item of information is a combination of a print file name of the print file and a print directory to which the print file belongs.

11. The image processing apparatus according to claim 4, wherein said print management section manages by correlating the first item of information to a plurality of image forming apparatuses to which the print data should be sent.

12. The image processing apparatus according to claim 1, wherein said print management section performs management by correlating the first item of information to a plurality of image forming apparatuses to which the print data should be sent.

13. An image processing system incorporating a first image processing apparatus according to claim 1, the system further comprising:
a transmitting section that transmits the print file to the first image forming apparatus; and
a second image processing apparatus that includes a destination registering section in which the first item of information that identifies and the second item of information are registered.
